(19) United States
(12) Patent Application Publication
(10) Pub. No.: US 2006/0113432 A1
(43) Pub. Date: Jun. 1, 2006

(54) Medical tube organizer

(76) Inventor: Terry A. Driskell, Maui, HI (US)

Correspondence Address: Christopher J. McDonald;HOFFMAN, WASSON & GITLER, P.C., Suite 522, 2461 South Clark Street, Arlington, VA, 22202, US

(21) Appl. No.: 10/997,924

(22) Filed: Nov. 29, 2004

(51) Int. Cl. F16L 3/22

(52) U.S. Cl. 248/68.1; 604/80

(57) ABSTRACT

The medical tube organizer has an elongated belt with an attachment device, such as a hook, on each end. Spaced along the belt are retainers. The retainers are widened sections of the organizer, having T-shaped and L-shaped posts extending upwardly. The spaces between the L-shaped and T-shaped posts releasably, but securely, retain a medical tube. The organizer may be attached to a patient bed, IV stand, or other support. The organizer retains the tubes in a separate arrangement, making their identification and maintenance easier.

### BACKGROUND OF THE INVENTION

Patients at hospitals and other persons undergoing medical treatment often have a variety of tubes serving medical purposes. These tubes include intravenous tubes, drainage tubes, feeding tubes and ventilation tubes. Often, a patient will have several types of the same tube. In this instance, it is imperative that the tubes be properly identified and separated so that medical personnel know the location and purpose of each tube. U.S. Pat. No. 4,316,461 (Marasis et al.) discloses an IV stabilizer having straps secured to a person. A base plate has clips for retaining IV tubes attached to the straps. Another example of an IV tube organizer is found in U.S. Pat. No. 5,224,674 (Simmons). Simmons discloses an IV organizer having a box with a series of notches and a cover to retain tubes in the notches. Also, U.S. Pat. No. 5,876,371 (Yokoyama et al.) discloses an IV tube holder.

There is a need in the prior art for a medical tube organizer capable of holding many tubes and attachable to a patient bed or other support.

It is an object of the invention to provide a medical tube organizer having structure to securely retain medical tubes.

It is another object of the invention to provide a medical tube organizer that is easy to use.

It is yet another object of the invention to provide a medical tube organizer clearly differentiating between several tubes attached to the organizer.

These and other objects of the invention will become apparent to one of ordinary skill in the art after reading the disclosure of the invention.

### SUMMARY OF THE INVENTION

The medical tube organizer has an elongated belt with an attachment device, such as a hook, on each end. Spaced along the belt are retainers. The retainers are widened sections of the organizer, having T-shaped and L-shaped posts extending upwardly. The spaces between the L-shaped and T-shaped posts releasably, but securely, retain a medical tube. The organizer may be attached to a patient bed, IV stand, or other support. The organizer retains the tubes in a separate arrangement, making their identification and maintenance easier.

### BRIEF DESCRIPTION OF THE DRAWINGS

FIG. 1 is a top view of the medical tube organizer;

FIG. 2 is a side view of the medical tube organizer; and,

FIG. 3 is a detailed view of the retention structure.

### DETAILED DESCRIPTION OF THE INVENTION

FIG. 1 shows the medical tube organizer 10 having a belt 12 with attachment devices 25 at each end. Any conventional attachment device can be used, such as the depicted hook. Along the length of the belt are a series of apertures 14. The apertures increase the flexibility of the belt allowing bending and twisting motion as needed when in use. The belt may be made of any resilient material, such as plastic. Spaced along the belt 12 are retainers 16. The details of the retainer 16 are explained hereinafter.

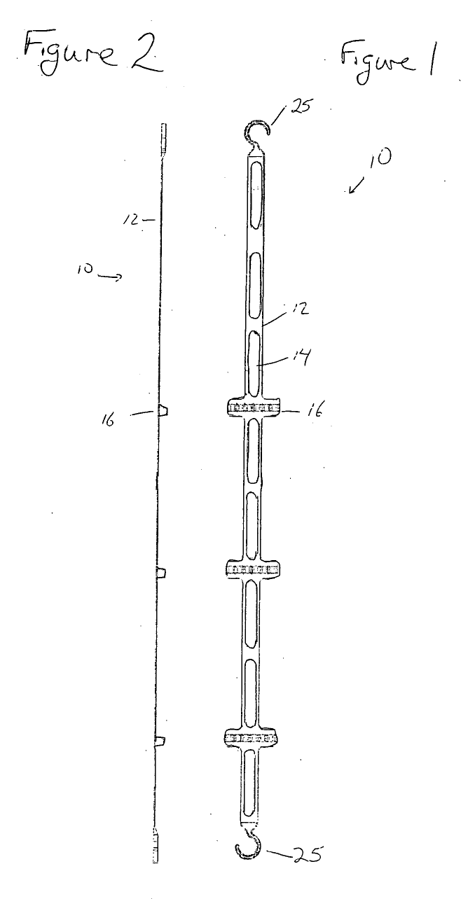

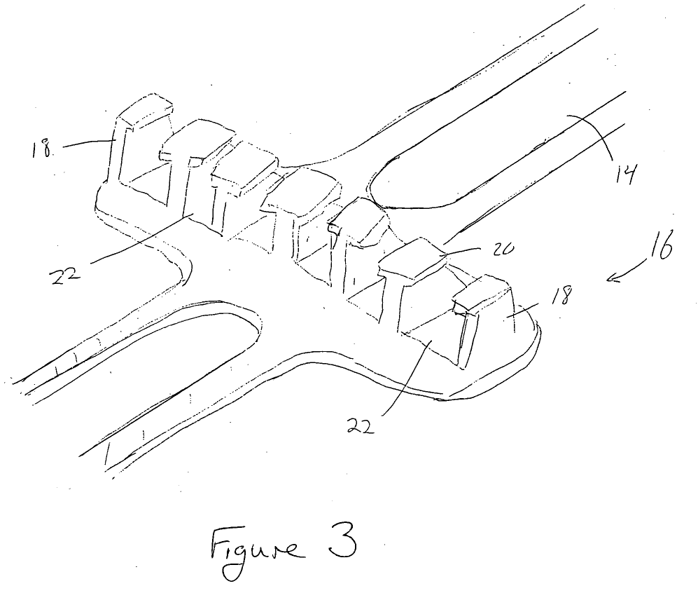

The side view of the medical tube organizer 10 can be seen in FIG. 2. This view shows the low profile of the belt portion 12 with the attachment devices 25 being thicker than the belt to handle the stresses and forces applied when the organizer is attached to a support, such as a bed or IV stand.

The structure of the retainer 16 is seen in the detailed view of FIG. 3. The retainer is on a widened section of the belt and has a series of upstanding posts spaced from one another. L-shaped posts 18 are at each end with T-shaped posts 20 between the end posts. Any number of T-shaped posts can be used, depending on the number of tubes to be organized. At least one T-shaped post is needed to separate two tubes. This creates a series of channels 22. The width of the channels 22 is enough to receive the medical tube to be retained. However, the top opening to the channel, formed between the posts, is smaller than the tubes. The resilience of the posts allows a tube to be pushed down from the top of the channel as the posts move to allow the insertion of the tube. However, once inserted into the channel, the tubes are securely retained until removed by medical personnel.

The series of retainers 16 spaced along the belt 12 allow the easy organization of the various tubes for a patient. The same tube will be placed in the corresponding channel 22 of each retainer 16 so that the identity of the tube is clearly known.

The medical tube organizer represents an easy way to organize various tubes securely so that the identity of each tube is clear to medical personnel.

While the invention has been described with reference to a preferred embodiment, various modifications would be apparent to one who is skilled in the art. The invention accomplishes such variations by modifications which do not depart from the scope of the invention.

I claim:

1. A medical tube organizer comprising
an elongated belt, having a first end and a second end,
an attachment device at each end of said elongated belt, and
medical tube retention devices spaced along said elongated belt.

2. The medical tube organizer of claim 1, further comprises
apertures in said elongated belt.

3. The medical tube organizer of claim 1, wherein
said attachment devices are hooks.

4. The medical tube organizer of claim 1, wherein
each retention device comprises a series of posts forming channels therebetween, for retaining a tube.

5. The medical tube organizer of claim 4, wherein
said series of posts comprises two L-shaped end posts and at least one T-shaped middle post.

6. The medical tube organizer, wherein
said at least one T-shaped post is a plurality of T-shaped posts.
